(19) United States
(12) Patent Application Publication
(10) Pub. No.: US 2025/0236147 A1
(43) Pub. Date: Jul. 24, 2025

(54) Dual Flex Spring for an Off Road Vehicle

(71) Applicant: Torrix, LLC, Orem, UT (US)

(72) Inventors: Ranch Pratt, Draper, UT (US); Cayson Patey, Springville, UT (US); Nick Reay, Elk Ridge, UT (US)

(21) Appl. No.: 19/033,468

(22) Filed: Jan. 21, 2025

Related U.S. Application Data
(63) Continuation of application No. 63/622,993, filed on Jan. 19, 2024.

(51) Int. Cl. B60G 11/14

(52) U.S. Cl. CPC B60G 11/14; B60G 2202/12; B60G 2204/124

(57) ABSTRACT

A dual flex spring assembly for an offroad vehicle (or any vehicle) is disclosed. The dual flex spring assembly may extend the suspension droop beyond the standard droop of a wheel of the vehicle while using a standard coil spring. For example, a dual flex spring assembly may include a top retaining plate having a hole, a bottom retaining plate, a bolt extending from the bottom retaining plate through the hole in the top retaining plate; a nut coupled with an end of the bolt adjacent to the top retaining plate; and an open-coiled helical spring disposed between the top retaining plate and the bottom retaining plate such that the bolt extends through a middle opening of the open-coiled helical spring.

### BACKGROUND

Offroad vehicles often require suspension that can handle extreme obstacles. Many solutions include lifting the vehicle in order to allow for more suspension to handle extreme obstacles. Yet, lifting a vehicle introduces other challenges.

### SUMMARY

A dual flex spring and/or spring assembly for an offroad vehicle is disclosed.

For example, a dual flex spring assembly may include a top retaining plate having a hole, a bottom retaining plate, a bolt extending from the bottom retaining plate through the hole in the top retaining plate; a nut coupled with an end of the bolt adjacent to the top retaining plate; and an open-coiled helical spring disposed between the top retaining plate and the bottom retaining plate such that the bolt extends through a middle opening of the open-coiled helical spring.

For example, the open-coiled helical spring is in its relaxed state. A dimension of the top retaining plate, for example, may be substantially the same as an outer diameter of the open-coiled helical spring. A dimension of the top retaining plate, for example, may be 20% larger than an outer diameter of the open-coiled helical spring. The bottom retaining plate, for example, may have a dimension that is larger than a dimension of the top retaining plate. The bottom retaining plate, for example, may have a surface area that is larger than the surface area of the top retaining plate. The open-coiled helical spring, for example, may have an outer diameter that is less than about four inches. The open-coiled helical spring, for example, may have a length that is less than about 20 inches. The dual flex spring assemble, for example, may include a coil spring disposed on the bottom retaining plate such that the open-coiled helical spring is arranged within a middle opening of the coil spring.

A suspension for a vehicle is also disclosed. The suspension may include a top retaining plate having a hole; a bottom retaining plate; a bolt extending from the bottom retaining plate through the hole in the top retaining plate; a nut coupled with an end of the bolt adjacent to the top retaining plate; an open-coiled helical spring disposed between the top retaining plate and the bottom retaining plate such that the bolt extends through a middle opening of the open-coiled helical spring; and a coil spring disposed on the bottom retaining plate such that the open-coiled helical spring is arranged within a middle opening of the coil spring.

The various embodiments described in the summary and this document are provided not to limit or define the disclosure or the scope of the claims.

### BRIEF DESCRIPTION OF THE FIGURES

FIG. 1 is a side view of a two dual flex spring assembly.

FIG. 2A shows two dual flex spring assemblies coupled with an axle coupled and wheels are on a flat surface.

FIG. 2B shows two dual flex spring assemblies coupled with an axle coupled and wheels are on a slightly uneven surface.

FIG. 2C shows two dual flex spring assemblies coupled with an axle coupled and wheels are on a largely uneven surface.

### DETAILED DESCRIPTION

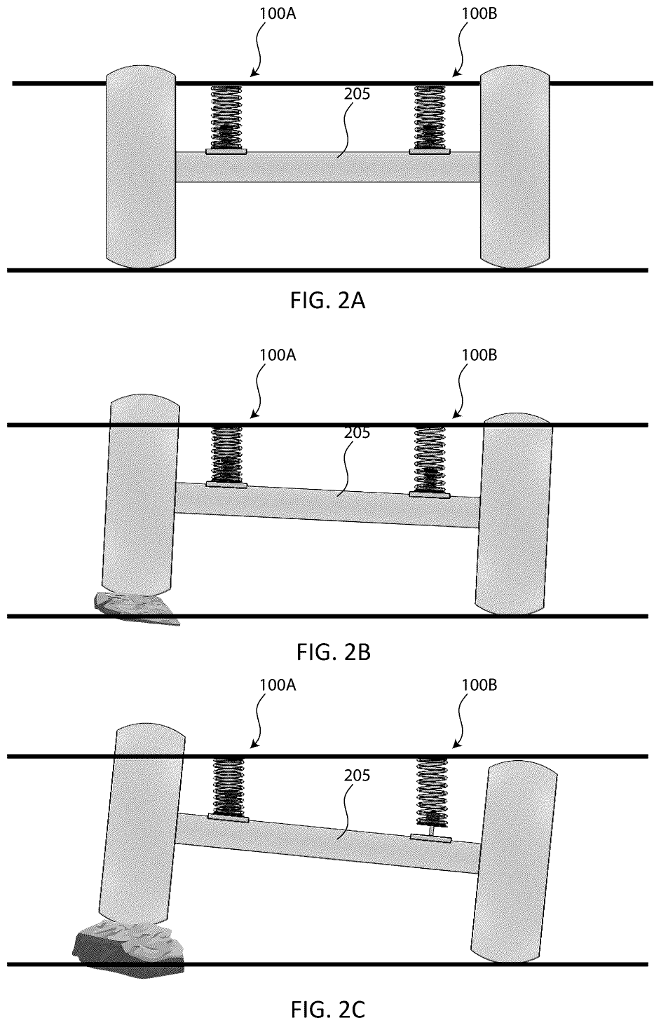

A dual flex spring assembly for an offroad vehicle (or any vehicle) is disclosed. The dual flex spring assembly may extend the suspension droop beyond the standard droop of the vehicle while using a standard coil spring. A suspension droop is the distance that one wheel of a vehicle extends downward when the other wheel, which is connected via an axel, extends upward when it encounters an obstacle on the path of the offroad vehicle. This is illustrated in FIGS. 2A, 2B, and 2C. FIG. 2A shows a level vehicle. FIG. 2B shows a standard droop where only the standard coil spring is engaged. The left wheel is raised up on an uneven surface and the right wheel is drooping to maintain contact with the road. And FIG. 2C shows a droop with the dual flex spring engaged and the right wheel is drooping further below the droop in FIG. 2B.

In some embodiments a dual flex spring assembly disclosed in this document can produce a wheel droop that can extend a wheel droop up to 3, 6, 9, 12 (see FIG. 2C) or more inches compared to a standard droop (see FIG. 2B).

In some embodiments a dual flex spring assembly disclosed in this document can produce a wheel droop that can extend a wheel droop up to 1-3, 3-6, 6-9, 9-12, 12-15 or more inches (see FIG. 2C) compared to a standard droop (see FIG. 2B). In some embodiments a dual flex spring assembly disclosed in this document can produce a wheel droop that can extend a wheel from 6-12 inches (see FIG. 2C) compared to a standard droop (see FIG. 2B).

In some embodiments a dual flex spring assembly disclosed in this document can produce a wheel droop that can extend a wheel droop of 10%-20%, 15%-25%, 20%-30%, 25%-35% inches (see FIG. 2C) compared to a standard droop (see FIG. 2B).

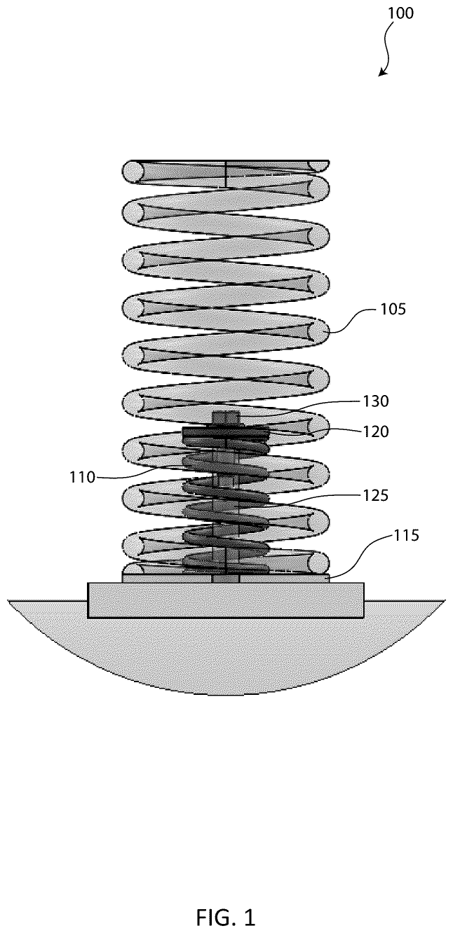

FIG. 1 is a side view of a dual flex spring assembly 100 that includes a standard coil spring 105 and a dual flex spring 110. The dual flex spring 110, for example, may include an open-coiled helical spring. The standard coil spring 105 is disposed between a top retaining plate 120 and a bottom retaining plate 115. A bolt 125 (or rod) extends from the bottom retaining plate 115 to a top retaining plate 120 through the middle of the dual flex spring 110. A top end of the bolt 125 may extend through a hole in the top retaining plate 120. A nut 130 (or cap) may be threaded on the end of the bolt 125. A bottom end of the bolt 125 may be coupled with the bottom retaining plate 115.

The dual flex spring 110, for example, may be disposed between the bottom retaining plate 115 and the top retaining plate 120 in the spring's relaxed state such as, for example, without compression or extension.

In use, the bottom retaining plate 115, for example, may be attached to the axle of a vehicle (e.g., a truck, SUV, ATV, jeep, automobile, etc.). In use, the bottom of the standard coil spring 105, for example, may be coupled with the bottom retaining plate 115 and the top of the standard coil spring 105 may be attached with the frame or body of the vehicle. In use, for example, the dual flex spring 110 may be disposed within the inner portion of the standard coil spring 105.

The dual flex spring 110, for example, may have a length that is less than about 10, 15, 20, or 25 inches. The dual flex spring 110, for example, may have a length that is less than half the length of the standard coil spring 105. The dual flex spring 110, for example, may have an outer diameter of less than about four (4) inches.

The standard coil spring 105 may be any type of coil spring for used in a vehicle. For example, the coil may include an after-market coil spring or an original coil spring for the vehicle. The standard coil spring 105, for example, may be coupled with the bottom retaining plate 115.

The top retaining plate 120, for example, may have a diameter that is substantially the same as the outer diameter of the dual flex spring 110 or 10% larger than the diameter of the dual flex spring 110.

The dual flex spring 110, for example, may have a compression strength that is less than the extension strength of the standard coil spring 105.

The bottom retaining plate 115, for example, may have a diameter that is about the diameter of the standard coil spring 105 or larger than the diameter of the standard coil spring 105.

FIG. 2A shows a first dual flex spring assembly 100A coupled with one side of an axle 205 and second dual flex spring assembly 100B coupled with the other side of the axle while the wheels are on a flat surface. While on the flat surface, the first dual flex spring 110A is neither extended nor compressed as shown in FIG. 1 and the second dual flex spring 110B is neither extended nor compressed as shown in FIG. 1.

FIG. 2B shows the axle 205 while the wheels are on a slightly uneven surface. In this example, the standard coil spring 105 of the second dual flex spring assembly 100B has not extended to a threshold extension and the dual flex spring 110 of the second dual flex spring assembly 100B has not compressed. In the example shown in FIG. 2B, the standard coil spring 105 of the first dual flex spring assembly 100A has not compressed to a threshold compression and the dual flex spring 110 of the second dual flex spring assembly 100B has not extended.

FIG. 2C shows the axle 205 while the wheels are on a significant uneven surface. In this example, the standard coil spring 105 of the second dual flex spring assembly 100B has extended to a threshold extension causing the bottom retaining plate 115 of the second dual flex spring assembly 100B to move upward compressing the dual flex spring 110 of the second dual flex spring assembly 100B between the bottom retaining plate 115 and the top retaining plate 120. This allows the wheel 210B to extend further downward while allowing the body of the vehicle to remain substantially level. In the example shown in FIG. 2C, the standard coil spring 105 of the first dual flex spring assembly 100A has compressed to a threshold compression causing the bottom retaining plate 115 of the first dual flex spring assembly 100A to move downward extending the dual flex spring 110 of the first dual flex spring assembly 100A between the bottom retaining plate 115 and the top retaining plate 120. This allows the wheel 210A to extend further upward while allowing the body of the vehicle to remain substantially level.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

While the present subject matter has been described in detail with respect to specific examples thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A dual flex spring assembly for an off road vehicle. comprising:
a top retaining plate having a hole;
a bottom retaining plate;
a bolt extending from the bottom retaining plate through the hole in the top retaining plate;
a nut coupled with an end of the bolt adjacent to the top retaining plate; and
an open-coiled helical spring disposed between the top retaining plate and the bottom retaining plate such that the bolt extends through a middle opening of the open-coiled helical spring.

2. The dual flex spring assemble according to claim 1, wherein the open-coiled helical spring is in its relaxed state.

3. The dual flex spring assemble according to claim 1, wherein a dimension of the top retaining plate is substantially the same as an outer diameter of the open-coiled helical spring.

4. The dual flex spring assemble according to claim 1, wherein a dimension of the top retaining plate is 20% larger than an outer diameter of the open-coiled helical spring.

5. The dual flex spring assemble according to claim 1, wherein the bottom retaining plate has a dimension that is larger than a dimension of the top retaining plate.

6. The dual flex spring assemble according to claim 1, wherein the bottom retaining plate has a surface area that is larger than the surface area of the top retaining plate.

7. The dual flex spring assemble according to claim 1, wherein the open-coiled helical spring has an outer diameter that is less than about four inches.

8. The dual flex spring assemble according to claim 1, wherein the open-coiled helical spring has a length that is less than about 20 inches.

9. The dual flex spring assemble according to claim 1, further comprising a coil spring disposed on the bottom retaining plate such that the open-coiled helical spring is arranged within a middle opening of the coil spring.

10. A suspension for a vehicle comprising:
a top retaining plate having a hole;
a bottom retaining plate;
a bolt extending from the bottom retaining plate through the hole in the top retaining plate;
a nut coupled with an end of the bolt adjacent to the top retaining plate;
an open-coiled helical spring disposed between the top retaining plate and the bottom retaining plate such that the bolt extends through a middle opening of the open-coiled helical spring; and
a coil spring disposed on the bottom retaining plate such that the open-coiled helical spring is arranged within a middle opening of the coil spring.

11. The dual flex spring assemble according to claim 10, wherein the open-coiled helical spring is in its relaxed state.

12. The dual flex spring assemble according to claim 10, wherein a dimension of the top retaining plate is substantially the same as an outer diameter of the open-coiled helical spring.

13. The dual flex spring assemble according to claim 10, wherein a dimension of the top retaining plate is 20% larger than an outer diameter of the open-coiled helical spring.

14. The dual flex spring assemble according to claim 10, wherein the bottom retaining plate has a dimension that is larger than a dimension of the top retaining plate.

15. The dual flex spring assemble according to claim 10, wherein the bottom retaining plate has a surface area that is larger than the surface area of the top retaining plate.

16. The dual flex spring assemble according to claim 10, wherein the open-coiled helical spring has an outer diameter that is less than about four inches.

17. The dual flex spring assemble according to claim 10, wherein the open-coiled helical spring has a length that is less than about 20 inches.

18. The dual flex spring assemble according to claim 10, further comprising a coil spring disposed on the bottom retaining plate such that the open-coiled helical spring is arranged within a middle opening of the coil spring.
